(19) United States
(12) Patent Application Publication
(10) Pub. No.: US 2023/0237571 A1
(43) Pub. Date: Jul. 27, 2023

(54) Risk Analysis System for Cold Restore Requests for Digital Wallets

(71) Applicant: Coinbase, Inc., San Francisco, CA (US)

(72) Inventors: Don Yu, Park City, UT (US); Zassmin Montes De Oca, Oakland, CA (US); Shamiq Islam, Oakland, CA (US); Eddie Gonzales, Toutle, WA (US); Tk Ng, Seattle, WA (US); Matthew Muller, Seattle, WA (US); Cassandra Rice, San Francisco, CA (US); Paul Hodapp, Denver, CO (US)

(21) Appl. No.: 17/582,459

(22) Filed: Jan. 24, 2022

(51) Int. Cl. G06Q 40/02; G06Q 20/36; G06N 20/00

(52) U.S. Cl. CPC G06Q 40/025; G06Q 20/3678; G06N 20/00; G06Q 2220/00

(57) ABSTRACT

Computing devices, methods, systems, and computer-readable media for analyzing requests to perform cold restores of cryptocurrencies are described herein. A computing device may receive a request for a cold restore of one or more cryptocurrencies stored by a digital wallet. The one or more cryptocurrencies may be identified, and data may be received from a database. The computing device may determine, based on the data, a risk score associated with the transfer of the one or more cryptocurrencies from a cold state to a hot state. The risk score may be generated using a machine learning model, such as a machine learning model that may be trained to output a risk score associated with a cold restore based on recent transaction activity. The computing device may output, based on comparing the risk score to a threshold, an indication of whether the request should be granted.

### FIELD

Aspects described herein generally relate to the secure storage and transmission of sensitive and valuable data on one or more networks. More particularly, aspects described herein provide techniques for analyzing and reacting to risk associated with requests to move one or more cryptocurrencies from cold storage to hot storage.

### BACKGROUND

Blockchains are a particular type of database software that have been under continuous development and constant improvement since Satoshi Nakamoto first published “Bitcoin: A Peer-to-Peer Electronic Cash System” in 2008. At its essence, a blockchain is a type of database that stores data only after that data is agreed upon by computers linked in a peer-to-peer (P2P) network, and where each “block” of data must be agreed upon before another block of data can be added. Blockchain data is said to be immutable insofar as, once a block is added to the blockchain, it cannot be changed or removed. In addition, blockchain algorithms typically operate based on “trustless” protocols, whereby none of the peers in the P2P network need to be affiliated with or trust each other in order for the block to be agreed upon and added to the Blockchain. To the contrary, it is actually preferable (and perhaps even required) that no single organization or entity controls greater than 50% of the peers on the network, because in such situations a majority actor could take over decision-making within many of the trustless protocols that blockchains use to add data to the blockchain. That majority actor could then add or alter data that might not otherwise be agreed upon by the entities acting reasonably when none of them has majority control. For this reason, blockchains typically may be queried by public APIs (often navigable via blockchain explorer web sites) so that their data can be readily audited, although some blockchains may remain private.

Blockchains can store any kind of data, although at their inception blockchains were primarily used to store digital tokens or cryptocurrency, such as Bitcoin (as used herein, “token” can refer to a cryptocurrency, virtual currency, digital token or any similar construct stored on a blockchain). Cryptocurrencies such as Bitcoin, however, merely use a blockchain as a means to transparently record their payment ledgers. Blockchains can also be used to immutably record any type of data, such as transaction data, votes in an election, product inventories and status, user identifications, deeds to homes, time and location information, and much more. Collectively, such data may be referred to as virtual assets, and such assets can be quite valuable.

In order to store tokens for users, each user can have one or more wallet “addresses” on the blockchain to which tokens can be attributed. Each address is typically the public key of a public/private key pair in an RSA and/or PM infrastructure used by the blockchain. When one user sends some amount of tokens to another user, the sending user's wallet software generates the relevant payment information (sender, receiver, and amount), signs the data using the sending wallet's private key, and submits the transaction to the blockchain for acceptance. Once accepted, the amount of sent tokens become attributed to the receiving wallet rather than the sending wallet in the blockchain's token ledger. In such a circumstance, the amount of sent tokens are associated with the receiving wallet, such that no other wallet (e.g., no other address) can spend the sent tokens.

As blockchains have developed, so have their capabilities. Some newer and more sophisticated blockchains allow users to run programs called smart contracts. A smart contract refers to a program that, once deployed, is stored as data on the blockchain itself and cannot be altered. Each smart contract has an associated address on the blockchain, and the source code of the smart contract defines how payments sent to the smart contract address are automatically processed and handled. Because the smart contract is stored on the blockchain itself, the source code for the smart contract can be audited by others to ensure the smart contract operates as intended or advertised. Smart contracts can be thought of as programs that act as self-executing contracts where the terms of the agreement between the buyer and the seller are directly written into lines of code. A user can send tokens directly to a wallet address associated with the smart contract, and the smart contract will execute based on the functions specified in its source code.

For example, a simple smart contract may act as a sort of flight cancellation insurance, where a user pays the smart contract 1% of the fare and receives a 100% refund if the flight is cancelled. In this example, a user may send an amount of cryptocurrency to a smart contract address as the purchase fee, along with data identifying a specific airline flight (e.g., airline, flight number, and date). The smart contract records the wallet address from which the “insurance” was purchased, and then monitors the flight status of the requested flight. The smart contract may check publicly accessible APIs providing flight information and, if the flight was canceled, automatically send to the wallet from which the insurance was purchased, a refund in the amount of 100% of the fare (e.g., 1× PurchaseFee). This is just a simple example for illustrative purposes. There are an infinite number of examples of smart contracts, each of varying complexity.

Some blockchains, in addition to general smart contracts, allow users to create individual tokens that can be exchanged on the blockchain. For example, the Ethereum blockchain includes smart contracts that themselves define a new token, separate from Ethereum, that can also be exchanged and tracked on the Ethereum network. These separate tokens' behaviors may be defined by one or more standards on the Ethereum network, the most common of which is referred to as the ERC-20 standard. ERC-20 is the technical standard used for all smart contracts on the Ethereum blockchain for token implementation and provides a list of rules that all Ethereum-based tokens must follow. Today there are over 350,000 different ERC-20 token contracts on the Ethereum blockchain alone. It is therefore infeasible for a human to individually analyze the features of each new token's smart contract, including any inherent security risks it exposes, on Ethereum and other blockchains.

The increasing (and often volatile) value of cryptocurrencies has made them a common target for theft and other malicious activities. As one example, if a malicious user learns of the private key for a particular wallet, the malicious user could use that information to extract one or more cryptocurrencies stored by that wallet. As another example, successful theft of authentication credentials associated with a victim may allow a malicious user to gain access to the victim's online accounts, which may include accounts associated with one or more digital wallets that store cryptocurrency.

Because many cryptocurrency custodians, exchanges, financial institutions, and/or investors store cryptocurrency for long periods of time, they often store cryptocurrency in a cold wallet: that is, a digital wallet that is stored in a manner that is disconnected from public networks and is thereby better protected from potential theft. For example, a digital wallet may be in a cold state (and referred to as a cold wallet) where a private key associated with the wallet is stored on a storage device disconnected from the Internet, stored in a safety deposit box, or similar secure non-networked location. Additional protections for the digital wallet might be implemented while the wallet is in a cold state: for example, the digital wallet might be encrypted, obfuscated, and/or otherwise modified so as to further protect it from malicious access. In contrast, a digital wallet may be in a hot state (and referred to as a hot wallet) when the private key is stored on a computer that is connected to a public network, such as the Internet, and can be used to immediately and/or programmatically trade one or more cryptocurrencies. This cold wallet approach is often significantly safer for long-term investors. By ensuring that their digital wallet(s) are not accessible via public networks such as the Internet, investors thereby better protect their cryptocurrency investments from theft, albeit at the expense of being unable to quickly access their cryptocurrency if/when desired. With that said, moving cryptocurrency from a cold wallet to a hot wallet is laborious, especially where cold storage mechanisms require manual human intervention. Moreover, cold restores might be initiated for malicious purposes. For example, a company might store, for their customers, cryptocurrency in cold storage. If a malicious user were able to impersonate a customer of that company (e.g., by stealing their authentication credentials and logging in to a website associated with the company), the malicious user might be able to initiate a cold restore of cryptocurrency, then later gain access to that cryptocurrency (and steal/sell it).

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed to techniques, methods, and systems to analyze the risk of, and implement, user requests to move one or more cryptocurrencies from a cold state to a hot state.

A computing device may receive a request for a cold restore of one or more cryptocurrencies stored by a digital wallet, wherein the request is configured to cause a transfer of the one or more cryptocurrencies from a cold state to a hot state. In the cold state, the one or more cryptocurrencies stored by the digital wallet may be inaccessible via a public network. In hot state, the one or more cryptocurrencies may be stored in a second digital wallet accessible to one or more users via the public network. The computing device may identify the one or more cryptocurrencies stored by the digital wallet. The computing device may receive, from one or more databases, an asset history corresponding to the one or more cryptocurrencies. The computing device may determine, based on the asset history, a risk score associated with the transfer of the one or more cryptocurrencies from the cold state to the hot state. The computing device may output, based on comparing the risk score to a threshold, an indication of whether the request should be granted.

This process may be implemented using a trained machine learning model. The computing device may determine the risk score by providing, as input to a trained machine learning model, the asset history. The trained machine learning model may have been trained, using training data comprising a history of a plurality of different cryptocurrencies, to output cold restore risk scores. The computing device may receive, as output from the trained machine learning model, the risk score.

As one example of how a machine learning model might be implemented, a system (e.g., one or more computing devices) may train, using training data, a machine learning model to output a risk score associated with a cold restore based on recent transaction activity. Such a cold restore may comprise a transfer of one or more cryptocurrencies from a cold state to a hot state. In the cold state, the one or more cryptocurrencies stored by a first digital wallet may be inaccessible via a public network. In contrast, in the hot state, the one or more cryptocurrencies may be stored in a second digital wallet accessible to one or more users via the public network. The training data may comprise information about historical cold restore activity, such as indications of whether one or more cold restore requests were granted or denied and/or transaction histories associated with time periods when the one or more cold restore requests were granted or denied. A request for a new cold restore of one or more first cryptocurrencies stored by a third digital wallet may be received. One or more computing devices of the system may provide, as input to the trained machine learning model, a first transaction history associated with the request. For example, that transaction history might indicate whether an attack on a blockchain has occurred. One or more computing devices of the system may receive, as output from the trained machine learning model, a first risk score and then output, based on comparing the first risk score to a threshold, an indication of whether the request should be granted. In such an example, one or more computing devices of the system may additionally and/or alternatively provide the machine learning model a variety of different types of input for the purposes of receiving a risk score. For example, the one or more computing devices of the system may provide, as input to the trained machine learning model, an indication of a limit associated with one or more wallets, an indication of a volatility of the one or more cryptocurrencies, an authentication credential usage history corresponding to an account associated with the request, a frequency of cold restore requests associated with the one or more cryptocurrencies, sentiment data corresponding to public discussion associated with the one or more cryptocurrencies, or the like.

This process may determine risk score based on a variety of considerations. The computing device may determine a historical volatility of one or more cryptocurrencies (e.g., the one or more cryptocurrencies) and/or a historical volatility of transactions (e.g., a frequency of cryptocurrencies transactions per unit time), such that the risk score may be determined based on the historical volatility. The computing device may compare a volatility of the one or more cryptocurrencies with a volatility of one or more second cryptocurrencies, such that the risk score may be determined based on the comparison. The computing device may determine an authentication credential usage history corresponding to an account associated with the request, such that the risk score may be based on the authentication credential usage history. The computing device may determine a frequency of cold restore requests associated with the one or more cryptocurrencies, such that the risk score may be based on the frequency of cold restore requests. The computing device may receive sentiment data corresponding to public discussion associated with the one or more cryptocurrencies, such that the risk score may be based on the sentiment data. The computing device may identify one or more blockchain addresses associated with recent transfers of the one or more cryptocurrencies and predict one or more entities associated with the one or more blockchain addresses, such that the risk score may be based on the predicted one or more entities. The computing device may determine a value of the one or more cryptocurrencies stored by the digital wallet, such that the risk score may be based on the value.

These and other aspects may be implemented as automated computerized methods, in one or more data processing systems operating substantially autonomously, as computer readable instructions (software) stored on one or more non-transitory computer readable media executable by a data processing system, or in any other statutory subject matter as defined by and interpreted under 35 USC § 101.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts a network architecture that may be used to implement one or more illustrative aspects described herein.

FIG. 2 depicts an example deep neural network architecture for a model according to one or more aspects of the disclosure.

FIG. 3 depicts an illustrative flowchart with steps depicting a method for determining a risk score associated with a request for a cold restore.

FIG. 4 depicts a flow of steps between a client and a Virtual Asset Service Provider (VASP) associated with a request for a cold restore.

FIG. 5 illustrates how multiple heuristics may be used to process a risk score for a request for a cold restore.

FIG. 6 depicts a flow of steps between modules of a VASP for handling a request for a cold restore.

FIG. 7 depicts a flow of steps between modules for handling a request for a cold restore.

FIG. 8 depicts a high-level diagram of how analysis may be performed using heuristics for a request for a cold restore.

FIG. 9 depicts an illustrative flowchart with steps depicting a method for determining a risk score associated with a request for a cold restore.

FIG. 10 depicts an illustrative flowchart with steps depicting a method for training a machine learning model based on cold restore activity.

### DETAILED DESCRIPTION

In the following description of the various embodiments, reference is made to the accompanying drawings, which form a part hereof, and in which is shown by way of illustration various embodiments in which aspects described herein may be practiced. It is to be understood that other embodiments may be utilized and structural and functional modifications may be made without departing from the scope of the described aspects and embodiments. Aspects described herein are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect connecting and coupling.

By way of background, one or more cryptocurrencies may be stored in a digital wallet. Such a digital wallet may correspond to a public key and a private key. Because anyone with knowledge of the private key can gain access to the cryptocurrencies stored by the digital wallet, the private key may be highly protected by users—and highly sought after by hackers and other malicious entities. To protect against malicious activities, long-term cryptocurrency custodians may hold their cryptocurrencies in cold wallets; that is, wallets where the private key may be stored in an offline, highly secure manner. For example, a user may store the only copy of their private key for a digital wallet on a portable storage device, then store that portable storage device in a safety deposit box. Given the popularity of this security approach, this cold storage service is increasingly being provided by Virtual Asset Service Providers (VASPs). For example, a VASP may store their customers' cryptocurrencies into digital wallets (e.g., a different digital wallet for each customer, or pooled wallets with aggregate funds), then store the private keys for those digital wallets in highly-secure offline storage. Later, when the VASP's customer(s) request access to their cryptocurrencies (e.g., to trade/sell them online), the VASP may require that the customer(s) submit formal requests, which might result in the need for funds to be transferred from a cold wallet to a hot wallet, which in turn may be manually reviewed by a human being before being approved. This often-laborious process may be referred to as a cold restore, whereby cryptocurrencies stored in a first digital wallet in a cold state (a “cold wallet”) are transferred to a second digital wallet in a hot state (a “hot wallet”).

One problem with the process of cold restoring is that it is time-consuming, slow, and introduces risk to the VASP and a customer. As indicated above, malicious users may try to initiate cold restores as part of their efforts to steal cryptocurrency from others. Cold restores may be performed, at least in part, by a human being (and by design, to prevent cold wallets from ever being connected to the Internet or other accessible via the Internet), but human beings can be fallible, and a human being can more easily mistakenly perform a cold restore in circumstances where the risk of performing such a cold restore is undesirably high. In other words, the process of a cold restore may, in some instances, involve a human being (e.g., as an added layer of security), but such human beings are ill-equipped to analyze the complex data associated with the risk of performing such a cold restore.

The process described herein addresses these and other issues by describing a system that determines a risk score for a cold restore and outputs an indication of whether a request for a cold restore should be granted. The process depicted herein preserves the disconnected nature of cold wallets (and maintains the human involvement in the actual process of retrieving the private key of a cold wallet) while also introducing processing steps which may allow for the analysis of a risk of a cold restore. In this manner, the improvements described herein may comprise a generic cryptocurrency/balance analysis machine that has flexibility in terms of input data and how it analyzes said data. For example, aspects described herein leverage machine learning models to process the potential risk of a cold restore in a manner that considers an asset history of a cryptocurrency, which may allow for cold restores to be rejected in circumstances where external factors (e.g., recent hacking activity, cryptocurrency volatility) may suggest that the cold restore could be malicious and/or otherwise undesirable. In this manner, VASP customers can be more comfortable in the manner in which VASPs store their cryptocurrencies.

Aspects described herein improve the functioning of computers by improving the security of digital assets, such as cryptocurrencies, in view of the fact that those assets may be stored in a manner which prevents them from being accessed by network resources. The digital assets involved in the present disclosure are necessarily computer-implemented, and the process described herein is rooted in a computing environment in that it relates to deciding whether to move those digital assets from secure storage (e.g., a storage device intentionally disconnected from public network(s)) to network-connected (and thereby potentially insecure) storage. Though some aspects of cold storage may be performed by a human (e.g., to add an additional layer of security), the process depicted herein could not be performed by a human being, whether or not with pen and paper: the assets and problem are computerized, and the manner in which the risk score described herein is calculated relies on fundamentally computer-implemented concepts such as machine learning models.

Before these and other improvements are disclosed in more detail, a computing environment with which various aspects of these improvements may be implemented is discussed.

Computing Environment

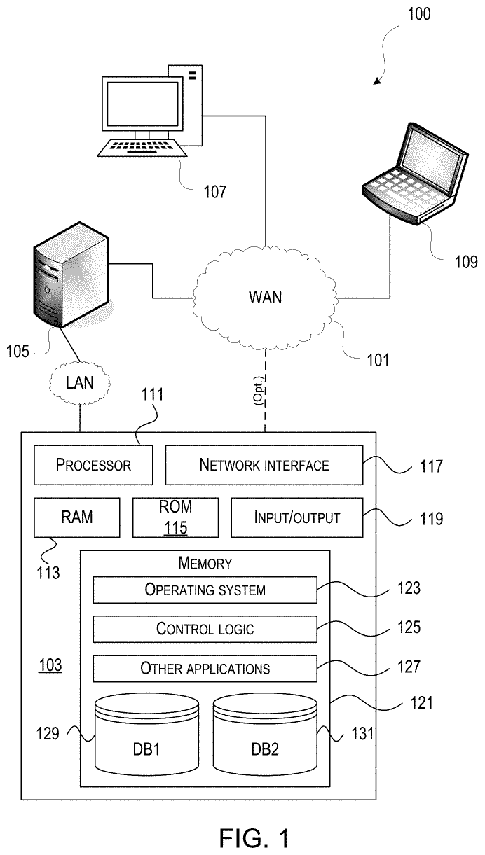

FIG. 1 illustrates one example of a network architecture 100 that may be used to implement one or more illustrative aspects described herein. Various network nodes 103, 105, 107, and 109 may be interconnected via a wide area network (WAN) 101, such as the Internet. Other networks may also or alternatively be used, including private intranets, corporate networks, LANs, wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, second server 105 (e.g., a web server, blockchain node, etc.), and client computers 107, 109. Data server 103 provides overall access, control and administration of databases and control software for performing one or more illustrative aspects described herein. Data server 103 may be connected to second server 105 through which users interact with and obtain data as requested. Alternatively, data server 103 may act or include the functionality of the second server itself and be directly connected to the Internet. Data server 103 may be connected to second server 105 through the network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access second server 105 using an Internet browser, as is known in the art, or by executing a software application that communicates with second server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device, e.g., laptops, desktops, tablets, smartphones, servers, micro-PCs, etc. Data server 103, e.g., may include a processor 111 controlling overall operation of the data server 103. Data server 103 may further include RAM 113, ROM 115, network interface 117, input/output interfaces 119 (e.g., keyboard, mouse, display, printer, etc.), and memory 121. I/O 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with other aspects described herein. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (QoS), etc.

One or more aspects described herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects, and such data structures are contemplated within the scope of computer executable instructions and computer-usable data described herein.

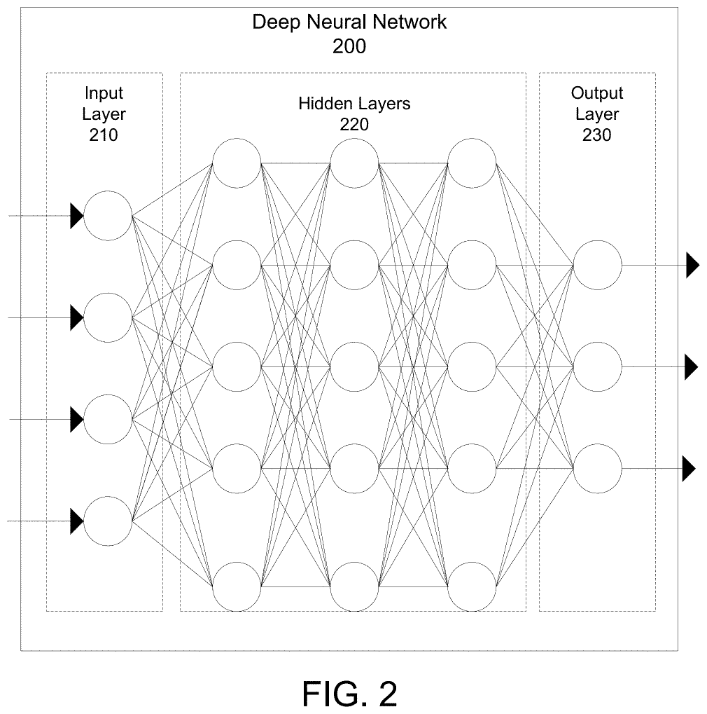

FIG. 2 illustrates an example deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 103, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model

Risk Analysis and Implementation of Cold Restores

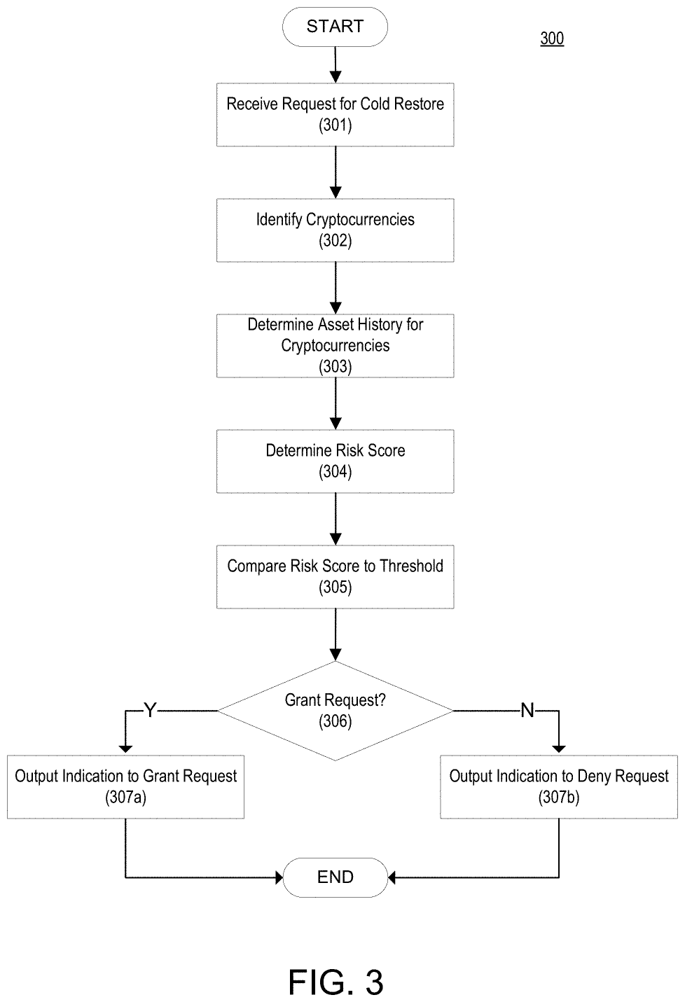

FIG. 3 depicts a flowchart 300 which may be performed to determine a risk score for a cold restore request. The steps depicted in FIG. 3 may be performed by one or more computing devices, such as one or more of the devices 103, 105, 107, 109. A computing device may be configured with one or more processors and memory storing instructions that, when executed by the one or more processors, cause the performance of one or more of the steps of FIG. 3. Additionally and/or alternatively, one or more non-transitory computer-readable media may store instructions that, when executed by one or more processors of a computing device, cause the computing device to perform one or more of the steps of FIG. 3. The steps depicted in FIG. 3 are illustrative, and may be omitted, re-arranged, and/or otherwise modified as desired. For example, step 302 and/or 303 may be merged, and/or step 307b may be omitted (e.g., such that an indication is output only when the request is granted).

In step 301, the computing device may receive a request for a cold restore. For example, the computing device may receive a request for a cold restore of one or more cryptocurrencies stored by a digital wallet. A request for a cold restore may be any indication that a user (e.g., a legitimate user that owns a digital wallet, a malicious user, or the like) wishes to move one or more cryptocurrencies from a cold wallet to a hot wallet. The request may be configured to cause a transfer of the one or more cryptocurrencies from a cold state to a hot state. The request may be received via a website or other similar application associated with a VASP. For example, a VASP website may allow users to purchase cryptocurrency, store the cryptocurrency in a hot digital wallet, move the cryptocurrency between the hot digital wallet and a cold digital wallet, and the like.

In a cold state, one or more cryptocurrencies stored by a digital wallet (e.g., a cold digital wallet) may be inaccessible via a public network, such as the Internet. The manner in which the one or more cryptocurrencies are stored in the cold digital wallet may be proprietary, and generally may be kept intentionally secret. That said, cold storage may differ from hot storage primarily in that, in a cold state, digital wallets (and the one or more cryptocurrencies they store) may be inaccessible via public networks, such as the Internet. In this manner, unauthorized activity conducted via the Internet (e.g., hacking) cannot reach the cold wallet and cryptocurrencies. For example, by storing the only copy of a private key for a digital wallet on a portable storage medium, turning that portable storage medium off, and then storing that portable storage medium in a safety deposit box (or similar secure physical storage area), an owner of that digital wallet may be assured that activity on the Internet cannot cause unauthorized access of the private key.

In a hot state, one or more cryptocurrencies may be stored in a digital wallet that is accessible to one or more users via a public network, such as the Internet. In this state, the private key for a digital wallet may be stored in a secure database, such that a user may—if desired—access (and, e.g., copy) the digital wallet's private key. In this manner, the user may be able to conduct transactions involving one or more cryptocurrencies stored by the digital wallet, such as selling and/or buying cryptocurrency. As indicated above, such a hot state may encompass a greater amount of risk than the cold state, as activity on a public network (e.g., scams, hacking, or other malicious activity) could potentially allow malicious entities to access (and thereby maliciously use) the digital wallet's private key.

In step 302, the computing device may identify one or more cryptocurrencies. For example, the computing device may identify one or more cryptocurrencies stored by the digital wallet. Identifying the one or more cryptocurrencies may comprise determining one or more identifiers of the one or more cryptocurrencies, such as a ticker or similar designation of the cryptocurrency (e.g., “BTC” for Bitcoin, “ETH” for Ethereum). Identifying the one or more cryptocurrencies may comprise identifying a quantity of the one or more cryptocurrencies associated with (e.g., stored by) the digital wallet. For example, the computing device may determine a quantity of each cryptocurrency stored by a particular digital wallet.

In step 303, the computing device may determine an asset history for the one or more cryptocurrencies. An asset history may correspond to the one or more cryptocurrencies and may indicate any information associated with changes in the one or more cryptocurrencies over time. For example, an asset history may indicate changes in a value of the one or more cryptocurrencies over time, a frequency with which the one or more cryptocurrencies are bought or sold, quantities of the one or more cryptocurrencies owned by one or more digital wallets over time, or the like. Such an asset history may be received from one or more databases. For example, the computing device may receive, from one or more databases, an asset history corresponding to the one or more cryptocurrencies.

The one or more cryptocurrencies for which an asset history is determined any be associated with one or more different organizations. For example, the asset history may correspond to the history of hot balance holdings for a particular organization, and/or the asset history may correspond to the history of hot balance holdings for a plurality of organizations. As another example, the asset history may correspond to recent activity by one or more addresses associated with an organization. In this manner, the asset history need not correspond to a holistic volatility of a cryptocurrency, but rather might relate to the particular asset history of a cryptocurrency owned by a particular organization.

In step 304, the computing device may determine a risk score. A risk score may be any objective and/or subjective evaluation of the risk of transferring the one or more cryptocurrencies from a cold state to a hot state. For example, the computing device may determine, based on the asset history, a risk score associated with the transfer of the one or more cryptocurrencies from the cold state to the hot state. As such, the risk score may be an indication as to whether the request for the cold restore should be granted in view of current circumstances involving the digital wallet, the one or more cryptocurrencies, or the like. The risk score may be represented as a Boolean value (e.g., “True” for risky, “False” for not risky), a percentage value (e.g., “40% risky”), a subjective evaluation of the risk (e.g., “somewhat risky”), or the like.

As one example of a risk score, a legitimate user may send a request for a cold restore (e.g., the request received in step 301) to later sell their cryptocurrency for a profit. In such a circumstance, the legitimate user's request should ordinarily be granted unless, for example, wallet anomalies/aberrations, market volatility, and/or recent hacking activity make it undesirably dangerous to move the user's cryptocurrencies into a state where they can be accessed by malicious users. As such, where a legitimate user provides the request for the cold restore and transfer of the funds would not be undesirably risky (e.g., because of the volatility of the one or more cryptocurrencies, because of recent hacking attacks, or the like), the risk score may be low. That said, in circumstances where a cryptocurrency may be very volatile, ongoing hacking attempts place cryptocurrencies at risk, or the like, the risk score may be relatively higher, and an otherwise legitimate cold restore request might be (temporarily) denied.

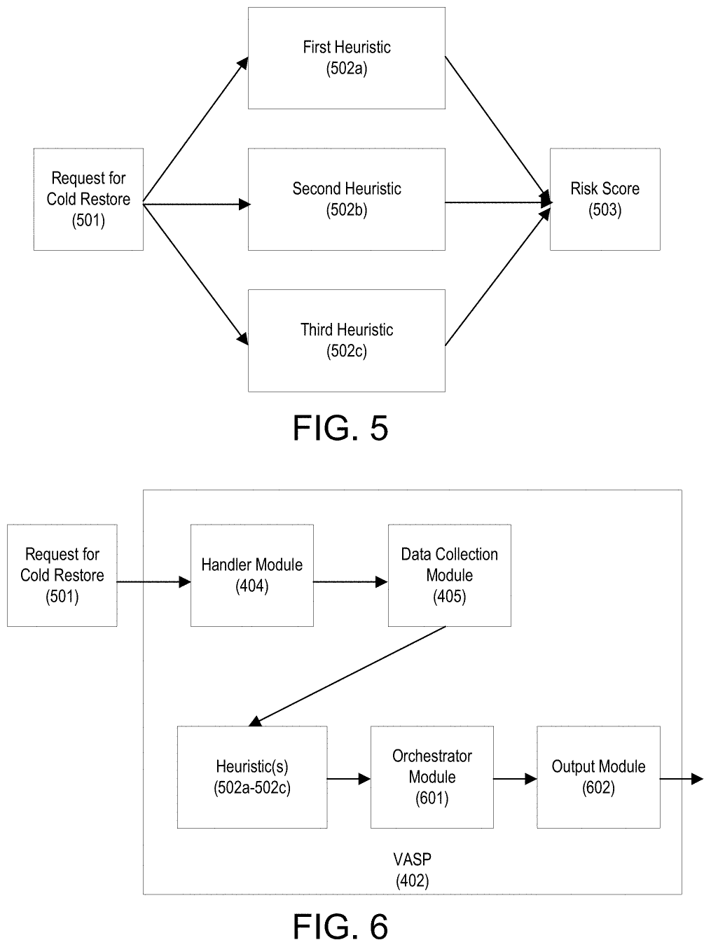

As will be described in greater detail below, the risk score might be calculated based on one or more different considerations and/or using one or more different algorithms. In this manner, the risk score might be, for instance, a weighted average of different scores provided by different heustistic algorithms. For example, as will be described in further detail with respect to FIG. 5, the risk score might be based on output from a plurality of different heuristics, such as algorithms which differently process the request for the cold restore (and, e.g., differently process the asset history). Such heuristics may be referred to as standalone heuristics when they focus on the current status of one or more cryptocurrencies, such as the current value of a cryptocurrency and/or the value of the cryptocurrency over a recent period of time (e.g., the last twelve hours). Such heuristics may be referred to as backwards-looking heuristics when they analyze past behavior of a digital wallet and/or the one or more cryptocurrencies, such as activities taken with a cold wallet in the past and/or the value of one or more cryptocurrencies in the past. Such heuristics may be referred to as lateral-looking when they analyze the activity of different digital wallets and/or cryptocurrencies than those involved in the request for cold restore. The data considered by such heuristics may be referred to as synchronous data if it is collected at the time the heuristic is run, whereas the data may be referred to as asynchronous data if the data has been previously retrieved (and, e.g., stored in a database).

Determining the risk score may be based on a value of one or more cryptocurrencies. The value of one or more cryptocurrencies (e.g., their exchange rate with fiat currencies, such as the United States dollar) may vary over time. Generally, users may be more likely to request cold restores in circumstances where the value is greater, such that they may sell their cryptocurrency and realize profit. That said, such circumstances may also encourage malicious users (e.g., hackers) to try to access others' digital wallets, recognizing the increased value of those wallets. The computing device may determine a value of the one or more cryptocurrencies stored by the digital wallet. For example, the computing device might query a database to identify an exchange rate that translates the value of one or more cryptocurrencies into one or more fiat currencies, such as the United States dollar, and the one or more cryptocurrencies may be then multiplied by the exchange rate. Then, the computing device may determine the risk score based on the value. For example, if the value has recently risen, the chance of a cold restore may be more likely, but the risk of a cold restore may be higher. After all, with more valuable cryptocurrency, the loss of that cryptocurrency due to hacking or other malicious activity may be more devastating.

Determining the risk score may comprise use of a machine learning model, such as may be implemented via the deep neural network 200 of FIG. 2. A machine learning model may be trained using training data. Training data may be tagged or untagged, and may be used to train the machine learning model to identify risks associated with cold restores when those cold restores are performed at different times. For example, the training data may comprise a history of a plurality of different cryptocurrencies and a history of cold restores associated with those cryptocurrencies, and the cold restores may (but need not) be tagged with indications of whether the cold restores were associated with malicious activity (e.g., theft). The computing device may provide, as input to the trained machine learning model, the asset history determined in step 303. The computing device may then receive, as output from the trained machine learning model, the risk score. In this manner, the machine learning model may leverage its knowledge about risk over time pertaining to cryptocurrencies to identify a risk, at a particular time, associated with a cold restore.

Determining the risk score may be based on a volatility of one or more cryptocurrencies. Significant amounts of cryptocurrency volatility may make a cold restore particularly risky because, for example, the transfer of cryptocurrencies from one wallet to another may take an undesirable amount of time, risk loss of the one or more cryptocurrencies, or the like. Moreover, high amounts of volatility associated with a particular cryptocurrency may be evidence that malicious activity is occurring with respect to the cryptocurrency. The computing device may compare a volatility of the one or more cryptocurrencies with a volatility of one or more second cryptocurrencies. For example, the computing device may compare a volatility of Ethereum over the last three days with volatilities of other cryptocurrencies (e.g., Bitcoin) over the same period. The computing device may additionally and/or alternatively determine a historical volatility of the one or more cryptocurrencies. For example, the computing device may compare a volatility of Ethereum over the last three days with the volatility of Ethereum in three-day periods over the last three months. The computing device may then determine the risk score based on that analysis. For example, if the volatility is high, the risk score may be accordingly somewhat higher.

As indicated above, the risk score might be based on the asset history of one or more cryptocurrencies, such as the asset history of a cryptocurrency owned by a particular organization. As just one example of this process, as part of step 303, an asset history of a cryptocurrency owned by a particular organization might be determined. For instance, that asset history may indicate the hot balance holdings of the organization over a period of time. Then, in step 304 and in the same example, the risk score may be based on whether the hot balance holdings of the organization over the period of time indicates a significant degree of risk for a cold restore. In this manner, a risk score might indicate whether volatility in the hot balance holdings of an organization might negatively impact the safety of a cold restore.

Determining the risk score may be based on a frequency of cold restore requests associated with the one or more cryptocurrencies. A recent increase in cold restore requests may be legitimate in some circumstances (e.g., where the value of one or more cryptocurrencies has increased, as indicated above). That said, the same increase in cold restore requests may be associated with malicious activity, such as a new security vulnerability allowing a malicious user to gain access to a large number of VASP accounts. As such, the computing device may determine a frequency of cold restore requests associated with the one or more cryptocurrencies. The computing device may then determine the risk score based on the frequency of cold restore requests. For example, if the frequency of cold restore requests is relatively high, then the risk score may be relatively high. On the other hand, if the frequency of cold restore requests is relatively low, then the risk score may be relatively low.

Determining the risk score may be based on the likelihood that an account may be used maliciously. A VASP may be able to ascertain, based on the services they provide to customers, whether recent account activity suggests that cold restores may be used somewhat maliciously. For example, if many user accounts serviced by the VASP have recently had their passwords stolen and/or if login activity associated with those accounts suggests a potential brute forcing attack, then the VASP may thereby learn that the likelihood of potentially malicious cold restores is somewhat higher than it otherwise normally would be. To learn of such activity, the computing device may determine an authentication credential usage history corresponding to one or more accounts associated with the request for the cold restore. Such an authentication credential usage history may indicate, for example, a history of unsuccessful attempts at logging into one or more accounts, an indication that a password associated with an account may have been recently stolen, or the like. The computing device may then determine the risk score based on the authentication credential usage history. For example, if recent account activity suggests potential malicious activity associated with an account, then the risk score may be relatively higher. As another example, if an account has not been used in years, then the risk score may be somewhat lower, as this suggests (as may be expected with some long-term cryptocurrency custodians) that the account was kept dormant intentionally.

Determining the risk score may be based on public discussion associated with one or more cryptocurrencies. Public discussions regarding cryptocurrencies may indicate one or more reasons why a cryptocurrency may be moved from cold to hot storage. For example, if recent news in foreign countries suggests a sell-off of institutionally-held cryptocurrency (such that the value of the cryptocurrency may plummet), some cryptocurrency investors may retrieve their cryptocurrency from cold storage and trade it for fiat currency or another cryptocurrency so as to avoid the impact of that sell-off. As another example, recent online forum discussions may suggest that some users are encouraging other users to sell and/or trade their cryptocurrencies for political reasons. The computing device may receive sentiment data corresponding to public discussion associated with the one or more cryptocurrencies. To receive such sentiment data, the computing device may be configured to periodically scrape online websites and/or databases associated with blogs, discussion forums, chatrooms, or the like and store text data from those sources in a database, which might be later processed (e.g., using natural language processing algorithms) to identify topics and/or trends. The computing device may then determine the risk score based on the sentiment data. For example, if recent chat room discussion in a popular cryptocurrency chatroom suggests the existence of recent hacking activity, the risk score may be relatively higher. In contrast, if the chat room discussion indicates that users are recommending to one another that they should trade one cryptocurrency for another, then the risk score may be relatively lower, as the cold restore may be associated with legitimate trading activity.

Determining the risk score may be based on recent transfers of one or more cryptocurrencies. In circumstances where malicious activity may be occurring with respect to cryptocurrency, many different maliciously-accessed digital wallets may be made to send their cryptocurrency holdings to one or more different wallets associated with a malicious user. In this way, a malicious user may, in effect, send themselves the cryptocurrencies from other digital wallets. In turn, sudden spikes of activity with respect to one address (e.g., one new digital wallet suddenly receiving a significant sum of cryptocurrency from unrelated digital wallets) may suggest malicious activity. As such, the computing device may identify one or more blockchain addresses associated with recent transfers of the one or more cryptocurrencies. For example, the computing device may monitor activity on the blockchain and identify one or more addresses that have recently been receiving cryptocurrency. The computing device may then predict one or more entities associated with the one or more blockchain addresses. For example, based on a database that correlates blockchain addresses with known entities (e.g., VASPs), the computing device may infer an identity of the one or more entities associated with blockchain addresses that have recently been receiving significant sums of cryptocurrency. The computing device may then determine the risk score based on the predicted one or more entities. For example, if recent activity suggests that a new digital wallet is receiving significant quantities of cryptocurrency from different digital wallets, and if information about that digital wallet suggests that it may be associated with a malicious entity (e.g., a hacker), then the risk score may be high. On the other hand, if recent activity suggests that most recent transfers of cryptocurrency are associated with blockchain addresses managed by known VASPs, then the risk score may be relatively lower.

A variety of different types of transaction histories might be taken into account when determining the risk score. In general, any sort of information relating to unusual transaction activity may indicate that a cold restore request might be somewhat riskier. For example, repeated transactions whereby one or more fractions of cryptocurrency are sent to entirely new blockchain addresses may be considered unusual under certain circumstances. As another example, attempts at thwarting consensus protocols to modify addresses or otherwise manipulate the blockchain may be considered unusual activity. One example of unusual transaction history may comprise evidence of a so-called majority attack, which is alternatively known as a 51% attack or a >50% attack. In such an attack, a malicious entity uses their dominance in hash rate and/or computing power to force a blockchain to accept potentially fraudulent transactions. By monitoring activity by different entities associated with a blockchain, such an attempted attack could be identified and factored into a risk analysis.

Determining the risk score may be based on one or more smart contracts. One or more cryptocurrencies may be associated with smart contracts. A blockchain associated with a first cryptocurrency may be configured to store programs (e.g., smart contracts) which may be configured to execute in response to certain conditions. For example, one program might be configured to issue funds (e.g., one or more quantities of cryptocurrency) in response to certain events. The existence of and/or activity relating to one or more smart contracts may indicate the riskiness of a cold restore. For example, if a smart contract has been recently deployed, the risk score may reflect that some legitimate users might seek to perform cold restores to gain access to their digital funds to use those funds with the smart contract. On the other hand, if a smart contract has recently been abused and/or misused (e.g., because a flaw in the smart contract has been discovered), the risk score may reflect the risk that the smart contract might be misused with respect to the restored digital funds.

As one example of how smart contract activity might affect a risk score, a risk score might be based on whether data external to a blockchain and used by a smart contract might be unreliable or otherwise compromised. Assume, for example, a smart contract configured to pay a user a predetermined amount (e.g., a refund) if a flight is cancelled. In such a circumstance, the smart contract might rely on one or more external databases to determine whether a particular flight has been cancelled. In such a circumstance, a malicious actor might be able to trigger the smart contract to issue payment by gaining unauthorized access to the one or more external databases. In this manner, activity external to a blockchain may cause cold restores involving the blockchain (e.g., involving one or more cryptocurrencies) to be a higher risk than normal. This is especially the case where the cold restore might provide the smart contract additional funds, as it might permit a malicious actor to extract more cryptocurrency via manipulation of the one or more databases.

As another example of how smart contract activity might affect a risk score, a smart contract might be inadvertently programmed in a manner which includes a bug that affects the safety of cold restores. Assume, as in the example above, a smart contract configured to pay a user a predetermined amount (e.g., a refund) if a flight is cancelled. With that said, the smart contract might inadvertently comprise a bug that permits a malicious user to request and receive multiple payments for the same flight cancellation. In such a circumstance, a bug in a smart contract might cause a particular cold restore to be a higher risk than it would otherwise. This is particularly the case where the cold restore might provide the smart contract additional funds, as it might permit a malicious actor to extract more cryptocurrency via requesting multiple payments for the same flight cancellation.

Determining the risk score may be based on limits to hot wallet holds. In some circumstances, organizations may elect to place limits on their hot wallet holdings. For example, an organization might agree with an insurer to hold no more than a certain quantity of a particular type of cryptocurrency in a hot wallet at any given time, thereby limiting the total exposure of that organization to theft should access to that hot wallet be maliciously acquired. As such, the risk score for a cold restore determined may be based, at least in part, on applicable limits. For example, if an organization's hot wallet is close to its limit, then the risk score might be higher than it would be if the organization's hot wallet is nowhere close to its limit. As another example, a risk score may indicate a maximum amount of riskiness (e.g., such that a cold restore request might be denied) in circumstances where a cold restore is predicted to cause one or more hot wallets to exceed a limit. In this manner, the risk score can act as a sort of emergency brake, preventing an organization from inadvertently performing a cold restore that, e.g., violates an insurance policy.

The limit used to determine the risk score may vary based on time, the one or more cryptocurrencies in question, or the like. For example, an insurance provider may, as part of an insurance agreement with an organization, permit the organization to store a greater quantity of a first cryptocurrency in hot wallets as compared to a second cryptocurrency. As another example, an insurance provider may permit an organization to store a greater quantity of cryptocurrency in hot wallets during its ordinary business hours, but may require that the organization store a lesser quantity of cryptocurrency in hot wallets outside of ordinary business hours.

In step 305, the computing device may compare the risk score determined in step 304 to a threshold. The threshold may be based on a time of day. For example, cold restores during daytime hours in the United States may be slightly more trustworthy, such that the threshold during these hours may be relatively more permissive. The threshold may be based on activity associated with one or more VASPs. For example, if a VASP is detecting potential network attacks on its servers, then the threshold may be configured to be less permissive, as the attacks may suggest possible malicious activity. The threshold may be based on a geographical location associated with the request received in step 301. For example, requests originating from the United States may be associated with a more permissive threshold than requests originating from countries associated with frequent malicious activity.

In step 306, the computing device may determine whether to grant the request received in step 301. Determining whether to grant the request received in step 301 may be based on comparing the risk score to the threshold, as is performed in step 305. For example, if the risk score satisfies the threshold, the computing device may grant the request, whereas if the risk score does not satisfy the threshold, the computing device may deny the request. If the computing device decides to grant the request, the flowchart 300 may proceed to step 307a. Otherwise, if the computing device decides to deny the request, the flowchart 300 may proceed to step 307b.

In step 307a, the computing device may output an indication that the request should be granted. The indication may be configured to start the process of a cold restore. That said, because some VASPs may configure the cold restore process to entail a human being at some point (e.g., to add a layer of delay and/or security), the entire process of a cold restore need not be automated. For example, the indication may cause display, in a user interface, of all or portions of the risk score, including a prompt as to whether one or more individuals should proceed with the cold restore process. The indication may additionally and/or alternatively comprise instructions for the cold restore process, such as which storage device(s) store the cold wallet (which might be determined by, e.g., querying a database).

In circumstances where the risk score is particularly low, step 307a may comprise automatically causing all or portions of the cold restore. In certain circumstances, the risk of a particular cold restore might be so low that denial of the cold restore may be unnecessary or undesirable. In such circumstances, the computing device might be configured to initiate all or portions of the cold restore. For example, as part of step 307a, the computing device may cause a particular device to be connected to the Internet, and/or may cause instructions to be displayed which prompt a human to reconnect the particular device to the Internet.

In step 307b, the computing device may output an indication that the request should be denied. The indication may comprise one or more details about the risk score, including one or more reasons for the risk score. For example, as part of step 307b, the computing device may process the asset history to determine one or more reasons for the risk score, and then may output the one or more reasons as part of outputting the indication that the request should be denied. In this manner, for example, a user may be informed that a cold restore is not possible because, e.g., recent hacking activity has made such activity undesirably risky.

The denial in step 307b need not suggest that the request for cold restore will be ultimately denied. For example, the denial in step 307b may indicate that further (e.g., manual) investigation into the request is required. In this manner, the denial might acknowledge that, while the risk score does not satisfy the threshold, there might nonetheless be circumstances where the cold restore should be granted.

As part of outputting the indication that the request should be denied, an indication of the request may be placed in a queue. The queue might comprise a list of one or more denied cold restore requests which may merit investigation by an administrator. Because this queue reflects denied cold restore requests that might ultimately be allowed by human involvement, this queue might be additionally and/or alternatively be referred to as a temporary queue and/or a jail. In this manner, output, by the computing device, of an indication that a request should be denied need not mean that the request be absolutely denied. Rather, certain denied requests might be placed in a queue, whereby administrators might manually remove the request from the queue (and, e.g., either affirm the denial of the request or reverse the denial and approve the cold restore request).

The queue may be configured to store cold restore requests where the risk score determined in step 304 indicates anything but an absolute unequivocal denial. Assume, in an illustrative system where a risk score of 0% indicates the most risk (e.g., the least safety) and a risk score of 100% indicates no risk (e.g., the most safety), that the threshold referenced in step 305 is 70%, such that cold restore requests are granted in step 306 if their risk score is equal to or greater than 70%. In such a circumstance, an indication that a cold restore request should be granted may be output if the risk score is at or equal to 70%, an indication that a cold restore request should be denied may be output if the risk score is equal to 0%, and an indication that a cold restore request should be denied may also be output if the risk score is greater than 0% and less than 70%. With that said, in the latter case (where the risk score is greater than 0% and less than 70%), an indication of the cold restore request may be added to a queue. In this manner, administrators may have the opportunity to correct circumstances where the risk score was inaccurate or otherwise incorrect.

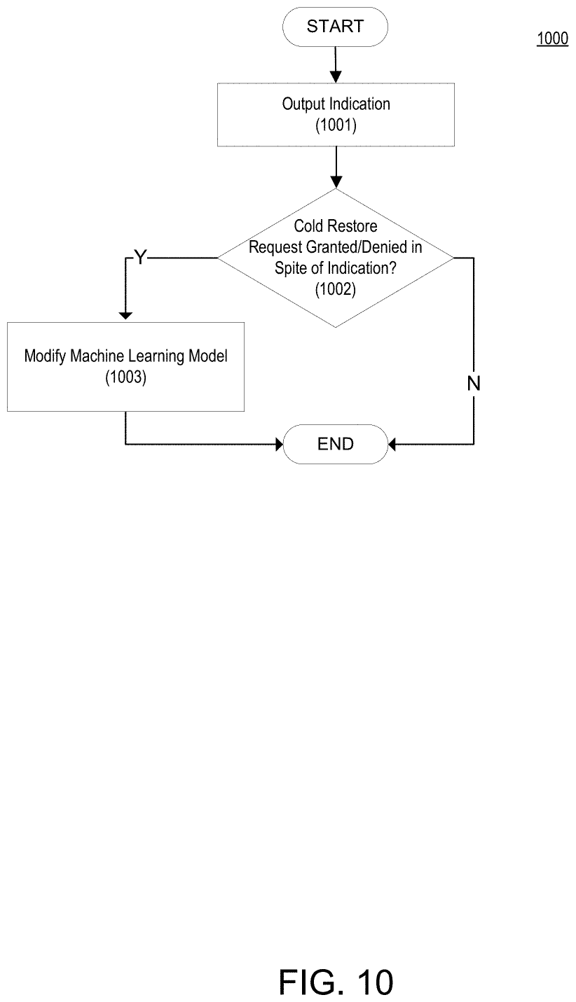

As will also be described further below with respect to FIG. 10, the fact that an administrator removes a cold restore request from a queue and grants that cold restore request might be used to modify one or more algorithms used to determine the risk score (e.g., as part of step 304). For example, in the circumstance where an administrator manually approves a cold restore request placed in a queue, an algorithm might be modified such that similar cold restore requests are given better risk scores in the future. This might apply in particular to the training of machine learning models. For example, in the case where an administrator manually approves a cold restore request placed in the queue, then a trained machine learning model might be modified (e.g., further trained) based on this allowance so as to improve the accuracy of the trained machine learning model in the future.

Given that a high number of cold restore requests might undesirably cause the queue to become long, cold restore requests may be added to a queue based on whether risk scores corresponding to those requests satisfy a threshold. In this manner, the queue might be populated with denied cold restore requests that actually merit administrator consideration, rather than simply acting as a list of cold restore requests that have been denied. For example, if risk scores are configured to be subjective values (e.g., “Not Risky,” “Somewhat Risky,” “Very Risky”), only indications of “Somewhat Risky” cold restore requests might be added to the queue, whereas “Very Risky” cold restore requests might be denied outright without being added to the queue.

The queue may be configured to be displayed in a user interface in a manner which permits users (e.g., administrators) to review and approve otherwise denied cold restore requests. For example, a user interface might comprise an indication of a cold restore request that has been denied as part of step 307b, a date and/or time when the cold restore request was received, the risk score corresponding to the cold restore request, one or more reasons why the cold restore request may have been provided the risk score (e.g., a reason why the cold restore request was considered particularly risky), and/or the like. In this manner, the processing described in FIG. 3 might be leveraged to provide users (e.g., administrators) valuable detail regarding a cold restore request, allowing them to better understand whether a cold restore request denied according to step 307b should in fact be granted.

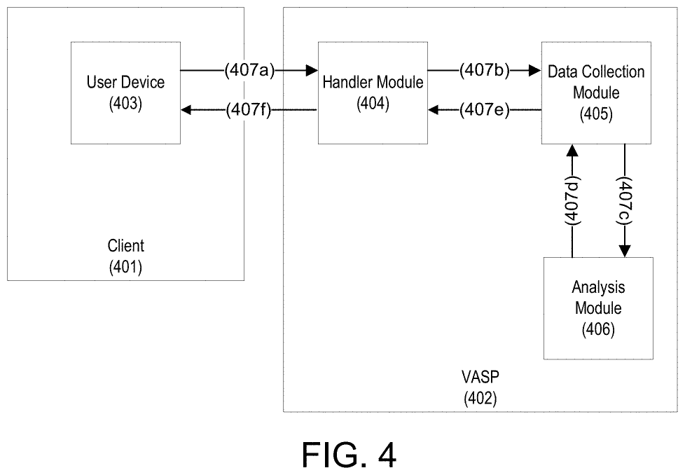

FIG. 4 depicts a flow of messages between different modules of a client 401 and a VASP 402. The client 401, which may correspond to a customer of the VASP, has a user device 403. The VASP 402 comprises a handler module 404, a data collection module 405, and an analysis module 406. Each of the user device 403, handler module 404, the data collection module 405, and the analysis module 406 may be one or more computing devices, such as described with respect to FIG. 1. For example, the user device 403 may comprise a smartphone, whereas the handler module 404 may be all or portions of a server.

Step 407a through step 407d describe how a risk score may be determined. In step 407a, the user device may send a request for a cold restore to the VASP 402 via the handler module 404. This step may comprise all or portions of step 301 of FIG. 3. In step 407b, the handler module 404 may identify one or more cryptocurrencies associated with the request and send indication(s) of the one or more cryptocurrencies to the data collection module 405. This step may comprise all or portions of step 302 of FIG. 3. In step 407c, the data collection module 405 may collect data including an asset history corresponding to the one or more cryptocurrencies and provide that asset history to the analysis module 406. This step may comprise all or portions of step 303 of FIG. 3. In step 407d, the analysis module 406 may determine a risk score based, at least in part, on the asset history and send the risk score to the data collection module 405. This step may comprise all or portions of step 304 of FIG. 3.

Step 407e through step 407f describe steps responsive to the risk score that was determined by the VASP 402. In step 407e, the data collection module 405 may send the risk score to the handler module 404. Then, in step 407e, the handler module 404 may send an indication of whether the risk score satisfies a threshold to the user device 403. In either of these steps, the either or both the data collection module 405 and/or the handler module 404 may compare the risk score to a threshold, as described in step 305 and step 306 of FIG. 3. Moreover, the indication sent by the handler module in step 407e may be the same or similar as the indications described in step 307a and/or step 307b of FIG. 3.

FIG. 5 illustrates how a request for a cold restore 501 (which may be the same or a similar request as discussed with respect to step 301 of FIG. 3) may be processed by multiple heuristics (here, for illustration purposes, three heuristics: a first heuristic 502a, a second heuristic 502b, and a third heuristic 502c) as part of determining a risk score 503. As indicated with respect to step 304 of FIG. 3, many different factors may be considered when determining a risk score. Each of these considerations (e.g., the output of a machine learning model, volatility in one or more cryptocurrencies, online messaging activity) may be analyzed by different heuristics, and/or different heuristics may use different algorithms to process the same or similar data. In this manner, the risk score 503 may reflect processing of the request for cold restore 501 based on a variety of different heuristics, rather than one heuristic (e.g., rather than one single algorithm). Each heuristic may be provided a different amount of weight based on, e.g., how probative it in detecting risk, how detailed it is, or the like. In turn, the output of each heuristic may be combined into the risk score 503.

FIG. 6 depicts another perspective of how the VASP 402 may use various modules to handle the request for cold restore 501. As with FIG. 4, each of the modules depicted in FIG. 6 may be one or more computing devices, such as those described with respect to FIG. 1. As depicted in FIG. 6, the request for cold restore 501 may be received by the handler module 404 (in a manner similar to step 301 of FIG. 3), which may pass on indication(s) of one or more currencies associated with the request to the data collection module 405 (in a manner similar to step 302 of FIG. 3). The data collection module 405 may then determine an asset history corresponding to the one or more cryptocurrencies and send that asset history for analysis by heuristics, such as the first heuristic 502a, second heuristic 502b, and the third heuristic 502c. That step may be the same or similar as step 303 of FIG. 3. These heuristics may provide output, and that output may be processed by an orchestrator module 601 to determine a risk score. That step may be the same or similar as step 304 of FIG. 3. That risk score may be compared to a threshold, and an indication of whether the request should be granted may be output via an output module 602. That step may be the same or similar as step 305, step 306, step 307a, and/or step 307b of FIG. 3.

One difference of note between FIG. 6 and FIG. 4 is that FIG. 6 depicts a circumstance wherein the output module 602 may provide output, but not necessarily back to the user device 403. Should the request for cold restore 501 be granted, for example, the output may instead be to a human tasked with manually performing the cold restore (by, e.g., retrieving a disconnected storage device, or the like).

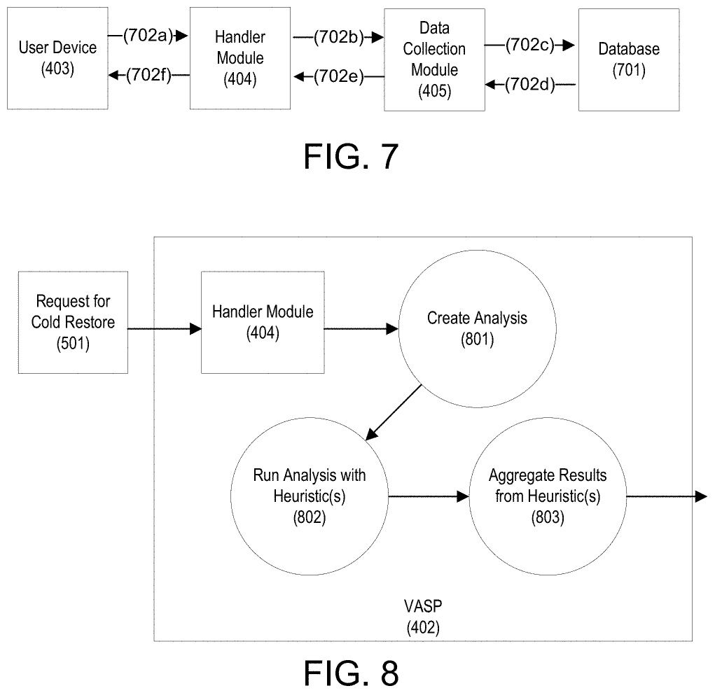

FIG. 7 depicts another way to visualize the flow between the user device 403, the handler module 404, and the data collection module 405. A database 701 is shown, which illustrates one source of data from which data (e.g., asset histories, exchange rates, or the like) may be determined. In step 702a, the user device 403 may send a request for a cold restore to the handler module 404. This may comprise all or portions of step 301 of FIG. 3. In step 702b, the handler module 404 may send an indication of one or more cryptocurrencies corresponding to the request to the data collection module 405. This may comprise all or portions of step 302 of FIG. 3. In step 702c, based on the one or more cryptocurrencies, the data collection module 405 may query the database 701 to determine one or more asset histories for the one or more cryptocurrencies. This may comprise all or portions of step 303 of FIG. 3. In step 702d, the data collection module 705 may receive (e.g., via the database 701), a risk score corresponding to the request, such as may have been generated by the analysis module 406. This may comprise all or portions of step 304 of FIG. 3. Such a process may have been performed by an additional step (not shown) where the data collection module 705 provides the asset history to the analysis module 406. In step 702e, the data collection module 705 may send the risk score to the handler module 404, which may compare the risk score to a threshold. This may comprise all or portions of step 305 of FIG. 3. In step 702f, the handler module may send an indication of whether the risk score satisfies a threshold to the user device 403. This may comprise all or portions of step 306, step 307a, and/or step 307b of FIG. 3.

FIG. 8 depicts how the steps within the VASP 402 may be conceptually understood. The request for cold restore 501 and the handler module 404 may be the same or similar as described above with respect to FIG. 4 and FIG. 5, such that FIG. 8, like FIG. 6, depicts a circumstance where the VASP 402 receives the request for cold restore 501 via the handler module 404. As shown in FIG. 8, this process may then entail a first step 801 involving creating an analysis of the request for cold restore 501, a second step 802 involving running an analysis of the request for cold restore 501 based on heuristics (e.g., the first heuristic 502a, the second heuristic 502b, and/or the third heuristic 502c), and a third step 803 indicating that results from the heuristics are aggregated to form a risk score upon which an indication is transmitted. These three conceptual steps might broadly correspond to steps 302-307b of FIG. 3.

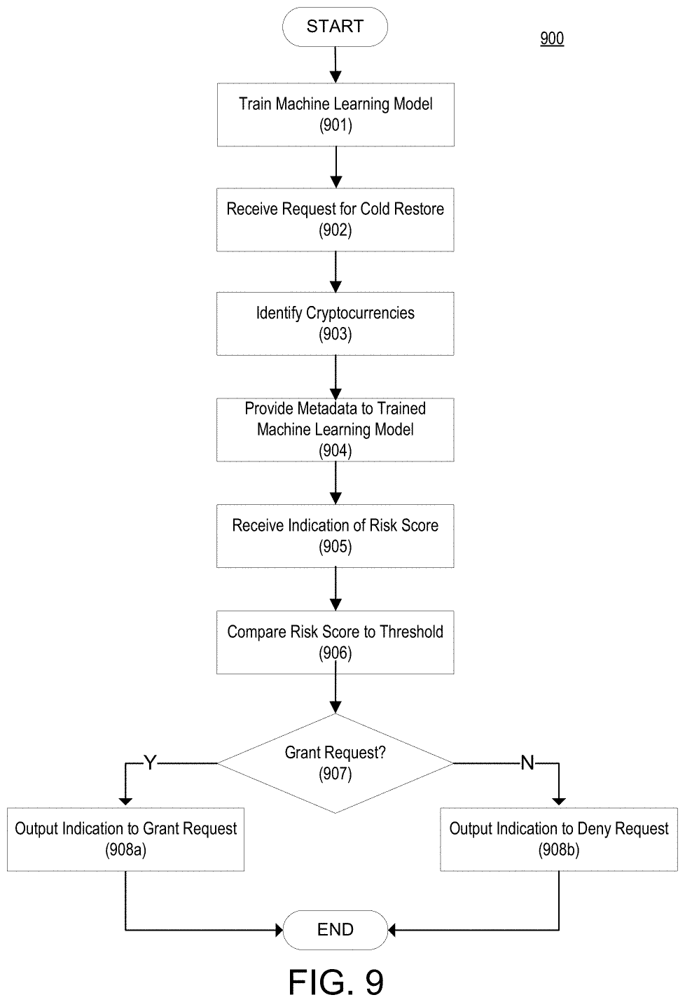

As a preliminary introduction to FIG. 9 and FIG. 10, one way that risk scores may be determined entails use of one or more machine learning models. By training machine learning models based on historical cold restore decisions (e.g., by humans, such as security administrators that manually perform such tasks), those machine learning models may be trained to emulate human decision-making regarding cold restore requests. Moreover, by analyzing whether the computing device's recommendations (e.g., the indications output in step 307a and/or step 307b) were followed by administrators, the machine learning models may be continually improved and might become better able to determine the risk of cold restore requests. This may uniquely leverage the fact that the machine learning models described herein need not automatically implement cold restores: after all, in many circumstances, cold restores might be intentionally (albeit minimally) human-involved for security reasons. Moreover, this process can ensure that the cold restore decision-making process is consistent from request to request.

FIG. 9 depicts an illustrative flowchart with steps depicting a method 900 for determining a risk score associated with a request for a cold restore. The steps depicted in FIG. 9 may be performed by one or more computing devices, such as one or more of the devices 103, 105, 107, 109. A computing device (e.g., one or more computing devices of a system) may be configured with one or more processors and memory storing instructions that, when executed by the one or more processors, cause the performance of one or more of the steps of FIG. 9. Additionally and/or alternatively, one or more non-transitory computer-readable media may store instructions that, when executed by one or more processors of a computing device, cause the computing device to perform one or more of the steps of FIG. 9. The steps depicted in FIG. 9 are illustrative, and may be omitted, re-arranged, and/or otherwise modified as desired.

In step 901, a machine learning model, such as a machine learning model implemented via the deep neural network 200, may be trained by one or more computing devices (e.g., one or more computing devices of a system). For example, one or more computing devices of a system may train, using training data, a machine learning model to output a risk score associated with a cold restore based on recent transaction activity. The training data used to train the machine learning model may indicate information relating to historical cold restore requests. For example, the training data may comprise indications of whether one or more cold restore requests were granted or denied. Additionally and/or alternatively, the training data may comprise transaction histories associated with time periods when one or more cold restore requests were granted or denied.

One strategy for training a machine learning model may be to train the machine learning model to indicate which circumstances relating to one or more cryptocurrency should result in cold restores being denied. As such, the training data used to train a machine learning model may indicate the circumstances during which a cold restore request was properly denied. For example, if a cold restore request was denied because of unusual cryptocurrency volatility, then the machine learning model might be provided information relating to that denied cold restore request, thereby teaching the machine learning model that certain types of cryptocurrency volatility should result in high risk scores. As another example, if a cold restore request was approved despite unusual cryptocurrency volatility because the amount to be restored was particularly low, then the machine learning model may be provided information relating to that approved cold restore request, and the machine learning model may thereby learn that cold restore requests involving relatively low quantities of cryptocurrency might be associated with relatively low risk scores despite unusual cryptocurrency volatility.

The training data for the machine learning model may be based on a history of cold restore decisions made by one or more individuals. In this manner, the trained machine learning model might be trained to make decisions in a manner that emulates previous decisions made by, e.g., a security team. For example, the training data might comprise information indicating cold restore request decisions made by a security team over a period of time (e.g., the last few years) and information about cryptocurrency volatility and value during that period of time.

The training data for the machine learning model may be based on the result of cold restore decisions made in the past. It may unfortunately be the case that some granted cold restore requests should not have been granted (and, e.g., led to the unauthorized acquisition of cryptocurrency), and/or that some denied cold restore requests improperly prevented legitimate users from gaining access to their cryptocurrency. As such, information about cold restore requests that were granted (and should not have been granted) and/or information about cold restore requests that were denied (and should not have been denied) might be valuable information for the purposes of training a machine learning model to identify the risk of cold restore requests.

The training data for the machine learning model may be tagged in a variety of ways. For example, the training data for the machine learning model may be tagged to indicate correct cold restore decisions (e.g., grants or denials of cold restore requests that were correct) and incorrect cold restore decisions (e.g., grants of cold restore requests that should have been denied, and/or vice versa). As another example, the training data for the machine learning model may be tagged to indicate a priority of certain data in a cold restore decision. For example, the training data might indicate that a particular cold restore request was denied, and the training data might be tagged to indicate that the denial was due to ongoing market volatility. As another example, the training data might be tagged to indicate that, in the decision of whether to grant a cold restore request, the amount of cryptocurrency involved in the cold restore request should be given more weight than market volatility.

In step 902, a request for a cold restore may be received. This step may be the same or similar as step 301 of FIG. 3. In step 903, one or more computing devices of the system may identify one or more cryptocurrencies. This step may be the same or similar as step 302 of FIG. 3.

In step 904, one or more computing devices of the system may provide metadata associated with the one or more cryptocurrencies to the trained machine learning model. The metadata provided to the trained machine learning model may be any information relating to the one or more cryptocurrencies determined in step 903. As such, the metadata may comprise any of the information discussed with respect to, for example, step 302, step 303, and/or step 304 of FIG. 3. For example, the metadata might comprise information relating to a volatility of the one or more cryptocurrencies, the value of the one or more cryptocurrencies, recent trading activity with respect to the one or more cryptocurrencies, public news relating to the one or more cryptocurrencies, smart contract activity associated with the one or more cryptocurrencies, or the like.

Whether or not metadata is provided to the trained machine learning model may be based on a reliability of all or portions of the metadata. In some circumstances, the validity and/or accuracy of different types of metadata relating to one or more cryptocurrencies might vary. In turn, it may be undesirable to provide the machine learning model particularly unreliable (e.g., inaccurate, potentially invalid) data, as it might cause the machine learning model to make imprecise cold restore decisions. As such, as part of step 904, one or more computing devices of the system may provide metadata associated with the one or more cryptocurrencies to the trained machine learning model based on a determination that the metadata satisfies an accuracy and/or validity threshold.

In step 905, one or more computing devices of the system may receive, from the trained machine learning model, output indicating all or portions of a risk score. The trained machine learning model may output a risk score (e.g., in a format the same or similar as described with respect to step 304 of FIG. 3). Additionally and/or alternatively, the trained machine learning model may output data which may be used to determine a risk score. For example, the trained machine learning model might indicate that three elements of the metadata indicate that the request should be granted, whereas two elements of the metadata indicate that the request should be denied. In such a circumstance, one or more computing devices of the system might use this output to, e.g., determine that the risk score is 60%.

In step 906, one or more computing devices of the system may compare the risk score to a threshold. This step may be the same or similar as step 304 of FIG. 3. In step 907, one or more computing devices of the system may determine whether to grant the request. This step may be the same or similar as step 306 of FIG. 3. If one or more computing devices of the system decide to grant the request, the method 900 proceeds to step 908a. Otherwise, if the one or more computing devices of the system decide to deny the request, the method 900 may proceed to step 908b. In step 908a, one or more computing devices of the system may output an indication to grant the request. This step may be the same or similar as step 307a of FIG. 3. In step 908b, one or more computing devices of the system may output an indication to deny the request. This step may be the same or similar as step 307b of FIG. 3.

As a preface to FIG. 10, it may be desirable to continually train a machine learning model based on whether cold restore requests were in fact granted or denied. The methods depicted in, e.g., FIG. 3 and FIG. 10 need not automatically cause a cold restore to be performed, but may instead simply output an indication as to whether such a cold restore should be granted or denied based on, e.g., a risk score. As such, it is possible that a cold restore may be granted even in circumstances where one or more computing devices of the system output an indication to deny the cold restore request, and/or that a cold restore request may be denied even in circumstances where the one or more computing devices of the system output an indication to approve the cold restore requests. These contradictions can be valuable training data for a machine learning model, as they may indicate that the machine learning model may have output an incorrect risk score.

FIG. 10 depicts an illustrative flowchart with steps depicting a method 1000 for training a machine learning model based on cold restore activity. The steps depicted in FIG. 10 may be performed by one or more computing devices, such as one or more of the devices 103, 105, 107, 109. A computing device, such as may be part of a system, may be configured with one or more processors and memory storing instructions that, when executed by the one or more processors, cause the performance of one or more of the steps of FIG. 10. Additionally and/or alternatively, one or more non-transitory computer-readable media may store instructions that, when executed by one or more processors of a computing device, cause the computing device to perform one or more of the steps of FIG. 10. The steps depicted in FIG. 10 are illustrative, and may be omitted, re-arranged, and/or otherwise modified as desired.

In step 1001, one or more computing devices of a system may output an indication to grant or deny a request. This step may be the same or similar as step 307a and/or step 307b of FIG. 3. In this manner, the process described with respect to FIG. 10 applies equally whether or not the indication is to grant or deny the request.

In step 1002, one or more computing devices of the system may determine whether a cold restore request corresponding to the indication referenced in step 1001 was granted or denied in spite of the indication. In other words, the one or more computing devices of the system may determine whether the cold restore request was granted or denied in a matter that contradicts the indication referenced in step 1001. As indicated above, such a result might suggest that, for example, the one or more computing devices of the system made the wrong recommendation, which might indicate that a trained machine learning model output a misleading and/or otherwise incorrect risk score. If the cold restore request was granted or denied in spite of the indication, the method 1000 proceeds to step 1003. Otherwise, the method 1000 ends.

One circumstance in which the circumstance described in step 1002 might arise is when an administrator manually approves a cold restore request in a queue. As indicated above with respect to FIG. 3, one or more computing devices of the system might maintain a queue of denied cold restore requests. If an administrator later approves a cold restore request in that queue, the fact that the computing device's determination was effectively contradicted might indicate that the risk score for that particular cold restore request was incorrect in some way.

In step 1003, one or more computing devices of the system may modify a trained machine learning model. Modifying the trained machine learning model may comprise training the machine learning model based on the determination that the cold restore request corresponding to the indication referenced in step 1001 was granted or denied in spite of the indication. For example, the trained machine learning model may be further trained using information indicating whether the cold restore request was in fact granted or denied, along with tagged metadata indicating which portion(s) of the metadata were relied upon in the decision to grant or deny the cold restore request. In some instances, as part of approving a cold restore request in a queue, an administrator might provide some sort of indication as to one or more reasons why the cold restore request was ultimately granted. In such a circumstance, the one or more reasons may be used to tag training data provided to the trained machine learning model.

Although the subject matter has been described in language specific to structural features and/or methodological acts, it is to be understood that the subject matter defined in the appended claims is not necessarily limited to the specific features or acts described above. Rather, the specific features and acts described above are disclosed as illustrative forms of implementing the claims.

What is claimed is:

1. A computing system comprising:
one or more processors; and
memory storing instructions that, when executed by the one or more processors, cause the computing system to:
train, using training data, a machine learning model to output a risk score associated with a cold restore based on recent transaction activity, wherein a cold restore comprises a transfer of one or more cryptocurrencies from a cold state to a hot state, wherein, in the cold state, the one or more cryptocurrencies stored by a first digital wallet are inaccessible via a public network, wherein, in the hot state, the one or more cryptocurrencies are stored in a second digital wallet accessible to one or more users via the public network, and wherein the training data comprises:
indications of whether one or more cold restore requests were granted or denied; and
transaction histories associated with time periods when the one or more cold restore requests were granted or denied;
receive a request for a new cold restore of one or more first cryptocurrencies stored by a third digital wallet;
provide, as input to the trained machine learning model, a first transaction history associated with the request;
receive, as output from the trained machine learning model, a first risk score; and
output, based on comparing the first risk score to a threshold, an indication of whether the request should be granted.

2. The computing system of claim 1, wherein the instructions, when executed by the one or more processors, further cause the computing system to:
provide, as input to the trained machine learning model, an indication of a limit associated with one or more wallets.

3. The computing system of claim 1, wherein the first transaction history indicates whether an attack on a blockchain has occurred.

4. The computing system of claim 1, wherein the instructions, when executed by the one or more processors, further cause the computing system to:
provide, as input to the trained machine learning model, an indication of a volatility of the one or more cryptocurrencies.

5. The computing system of claim 1, wherein the instructions, when executed by the one or more processors, further cause the computing system to:
provide, as input to the trained machine learning model, an authentication credential usage history corresponding to an account associated with the request.

6. The computing system of claim 1, wherein the instructions, when executed by the one or more processors, further cause the computing system to:
provide, as input to the trained machine learning model, a frequency of cold restore requests associated with the one or more cryptocurrencies.

7. The computing system of claim 1, wherein the instructions, when executed by the one or more processors, further cause the computing system to:
provide, as input to the trained machine learning model, sentiment data corresponding to public discussion associated with the one or more cryptocurrencies.

8. A method comprising:
training, using training data, a machine learning model to output a risk score associated with a cold restore based on recent transaction activity, wherein a cold restore comprises a transfer of one or more cryptocurrencies from a cold state to a hot state, wherein, in the cold state, the one or more cryptocurrencies stored by a first digital wallet are inaccessible via a public network, wherein, in the hot state, the one or more cryptocurrencies are stored in a second digital wallet accessible to one or more users via the public network, and wherein the training data comprises:
indications of whether one or more cold restore requests were granted or denied; and
transaction histories associated with time periods when the one or more cold restore requests were granted or denied;
receiving a request for a new cold restore of one or more first cryptocurrencies stored by a third digital wallet;
providing, as input to the trained machine learning model, a first transaction history associated with the request;
receiving, as output from the trained machine learning model, a first risk score; and
outputting, based on comparing the first risk score to a threshold, an indication of whether the request should be granted.

9. The method of claim 8, further comprising:
providing, as input to the trained machine learning model, an indication of a limit associated with one or more wallets.

10. The method of claim 8, wherein the first transaction history indicates whether an attack on a blockchain has occurred.

11. The method of claim 8, further comprising:
providing, as input to the trained machine learning model, an indication of a volatility of the one or more cryptocurrencies.

12. The method of claim 8, further comprising:
providing, as input to the trained machine learning model, an authentication credential usage history corresponding to an account associated with the request.

13. The method of claim 8, further comprising:
providing, as input to the trained machine learning model, a frequency of cold restore requests associated with the one or more cryptocurrencies.

14. The method of claim 8, further comprising:
providing, as input to the trained machine learning model, sentiment data corresponding to public discussion associated with the one or more cryptocurrencies.

15. One or more non-transitory computer-readable media storing instructions that, when executed by one or more processors of a computing system, cause the computing system to:
train, using training data, a machine learning model to output a risk score associated with a cold restore based on recent transaction activity, wherein a cold restore comprises a transfer of one or more cryptocurrencies from a cold state to a hot state, wherein, in the cold state, the one or more cryptocurrencies stored by a first digital wallet are inaccessible via a public network, wherein, in the hot state, the one or more cryptocurrencies are stored in a second digital wallet accessible to one or more users via the public network, and wherein the training data comprises:
indications of whether one or more cold restore requests were granted or denied; and
transaction histories associated with time periods when the one or more cold restore requests were granted or denied;
receive a request for a new cold restore of one or more first cryptocurrencies stored by a third digital wallet;
provide, as input to the trained machine learning model, a first transaction history associated with the request;
receive, as output from the trained machine learning model, a first risk score; and
output, based on comparing the first risk score to a threshold, an indication of whether the request should be granted.

16. The non-transitory computer-readable media of claim 15, wherein the instructions, when executed by the one or more processors, further cause the computing system to:
provide, as input to the trained machine learning model, an indication of a limit associated with one or more wallets.

17. The non-transitory computer-readable media of claim 15, wherein the first transaction history indicates whether an attack on a blockchain has occurred.

18. The non-transitory computer-readable media of claim 15, wherein the instructions, when executed by the one or more processors, further cause the computing system to:
provide, as input to the trained machine learning model, an indication of a volatility of the one or more cryptocurrencies.

19. The non-transitory computer-readable media of claim 15, wherein the instructions, when executed by the one or more processors, further cause the computing system to:
provide, as input to the trained machine learning model, an authentication credential usage history corresponding to an account associated with the request.

20. The non-transitory computer-readable media of claim 15, wherein the instructions, when executed by the one or more processors, further cause the computing system to:
provide, as input to the trained machine learning model, a frequency of cold restore requests associated with the one or more cryptocurrencies.
